(19) United States
(12) Patent Application Publication
(10) Pub. No.: US 2013/0080342 A1
(43) Pub. Date: Mar. 28, 2013

(54) Preservation of Documents in a Hosted User Environment

(71) Applicants: Mayank Talati, Hyderabad (IN); Dan Belov, San Francisco, CA (US); Gopinath Thota, Hyderabad (IN); Shaunak Godbole, Union City, CA (US); Gary Young, Mountain View, CA (US); Bill Kee, San Francisco, CA (US); Suman Gundapaneni, Andhra Pradesh (IN)

(72) Inventors: Mayank Talati, Hyderabad (IN); Dan Belov, San Francisco, CA (US); Gopinath Thota, Hyderabad (IN); Shaunak Godbole, Union City, CA (US); Gary Young, Mountain View, CA (US); Bill Kee, San Francisco, CA (US); Suman Gundapaneni, Andhra Pradesh (IN)

(73) Assignee: Google Inc., Mountain View, CA (US)

(21) Appl. No.: 13/435,139

(22) Filed: Mar. 30, 2012

(30) Foreign Application Priority Data
Mar. 30, 2011 (IN) 1025/CHE/2011

(51) Int. Cl. G06Q 50/18; G06F 17/30

(52) U.S. Cl. CPC G06Q 50/18; G06F 17/30014
USPC 705/311; 707/741

(57) ABSTRACT

Organizations struggle to meet their obligation to preserve electronic documents when litigation occurs or is likely. This is particularly challenging in a hosted user environment using a distributed file system. Embodiments of the invention enable a user to preserve email, chats, text documents, and other electronic files in the native storage systems of these applications, or in a hosted eDiscovery archive that syncs with the native store. In an embodiment, the process uses a label to indicate that a particular document should not be deleted. When purging tasks occur, the documents with such labels are exempt from purging until the label is removed. Search queries may also be run on the documents in their native locations to identify those relevant to a litigation hold. Because the system operates on the native document store, a user is not required to create a copy of the document in order to preserve it.

### CROSS-REFERENCE TO RELATED APPLICATIONS

This application claims priority to Indian Provisional Application No. 1025/CHE/2011, filed Mar. 30, 2011, which is incorporated by reference herein in its entirety.

### BACKGROUND

Electronic discovery tools are used in the majority of modern court proceedings to capture and review documents that may be relevant to a particular proceeding. Conventional electronic discovery tools are used to duplicate various devices used in a company, extract potentially relevant information, and load it into a database or other repository for review.

In a given litigation or court proceeding, a number of users may need to be placed on litigation hold. Litigation hold requires that a user does not delete or modify documents that may be potentially relevant to the litigation, and that may be used as evidence. Litigation hold is intended to preserve these documents and allow them to be admissible as evidence before a court.

### BRIEF SUMMARY

In accordance with one aspect of the invention, a method of preserving documents for a litigation hold is described. One or more preservation criteria for a litigation hold is received. Documents satisfying the preservation criteria are located across a plurality of client devices. The located documents are labeled with an indication that the document is on litigation hold and should not be modified or deleted. An index of links to the labeled documents, such that the documents are maintained in their respective states while accessible by a review tool, is maintained.

In accordance with another aspect, an exploratory query is created to test preservation criteria before labeling documents.

In accordance with another aspect, documents subject to the litigation hold are monitored. A request to modify a document subject to the litigation hold is received, and a copy of the original document is created in order to preserve the original for litigation hold purposes.

In accordance with another aspect, documents subject to the litigation hold are monitored. A request to delete a document subject to litigation hold is received, and the document is removed from user view. The document is maintained in its respective state for litigation hold purposes.

In accordance with another aspect, a document may have one or more labels corresponding to one or more litigation holds.

In accordance with an aspect of the invention, additional desired preservation criteria are received. Documents satisfying the additional preservation criteria are located and labeled, where the label is an indication that the document is on litigation hold and should not be modified or deleted. The index of links to located documents is updated to include the newly found documents.

In accordance with an aspect of the invention, a label is removed from a document upon termination of the litigation hold.

In accordance with an aspect of the invention, a method of enabling review of documents in a hosted user environment is described. A query with desired search criteria is received, and documents satisfying the search criteria are located across a plurality of client devices. An index of links to documents in their native state that satisfy the search criteria is created. Finally, analysis on documents is enabled while maintaining the documents in their native state.

In accordance with a further aspect of the invention, the index of links to documents satisfying the search criteria may be divided among one or more reviewers.

In accordance with a further aspect, the index may be divided among reviewers in accordance with desired criteria.

Further embodiments, features, and advantages, as well as the structure and operation of the various embodiments of the invention are described in detail below with reference to accompanying drawings.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a list of files and associated users used in various examples.

FIG. 2 is a diagram of a traditional computing environment.

FIG. 3 is a diagram of an exemplary hosted user environment that may be used in accordance with an embodiment.

FIG. 4 is an illustration of an exemplary hosted user environment utilizing a distributed file system that may be used in accordance with an embodiment.

FIG. 5 is a flow diagram of a method of preserving documents in a hosted user environment, in accordance with an embodiment.

FIG. 6 is a sample index of files, in accordance with an embodiment.

FIG. 7 is a flow diagram of a method of preserving a modified document under litigation hold in a hosted user environment, in accordance with an embodiment.

FIG. 8A is a sample index of files, in accordance with an embodiment.

FIG. 8B is a sample index of files, in accordance with an embodiment.

FIG. 9 is a flow diagram of a method of preserving a deleted document under litigation hold in a hosted user environment, in accordance with an embodiment.

FIG. 10 is a sample index of files, in accordance with an embodiment.

FIG. 11 is a flow diagram of a method of updating a set of documents on litigation hold in a hosted user environment, in accordance with an embodiment.

FIG. 12 is a sample index of files, in accordance with an embodiment.

FIG. 13 is a flow diagram of a method of enabling review of documents in a hosted user environment, in accordance with an embodiment.

FIG. 14 is a sample index of files, in accordance with an embodiment.

FIG. 15 is an illustration of a litigation hold system, in accordance with an embodiment.

### DETAILED DESCRIPTION

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

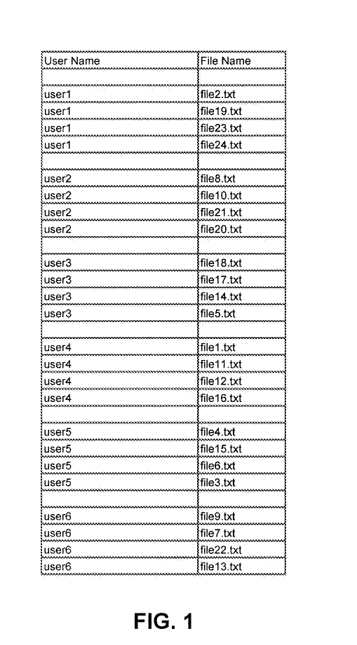

The following explanations of various embodiments use the table of FIG. 1 as an exemplary reference point. FIG. 1 displays a list of 24 exemplary files, file1.txt through file24.txt, and 6 exemplary users, user1 through user6. In this example, each user has four files associated with it.

The traditional model of business computing involves individual user machines connected to a network. Also connected to the network are various servers controlling functions such as electronic mail and authentication. In this model, documents generated by individual users are primarily stored on their individual devices, such as desktop computers, laptop computers, tablet devices, or mobile phones.

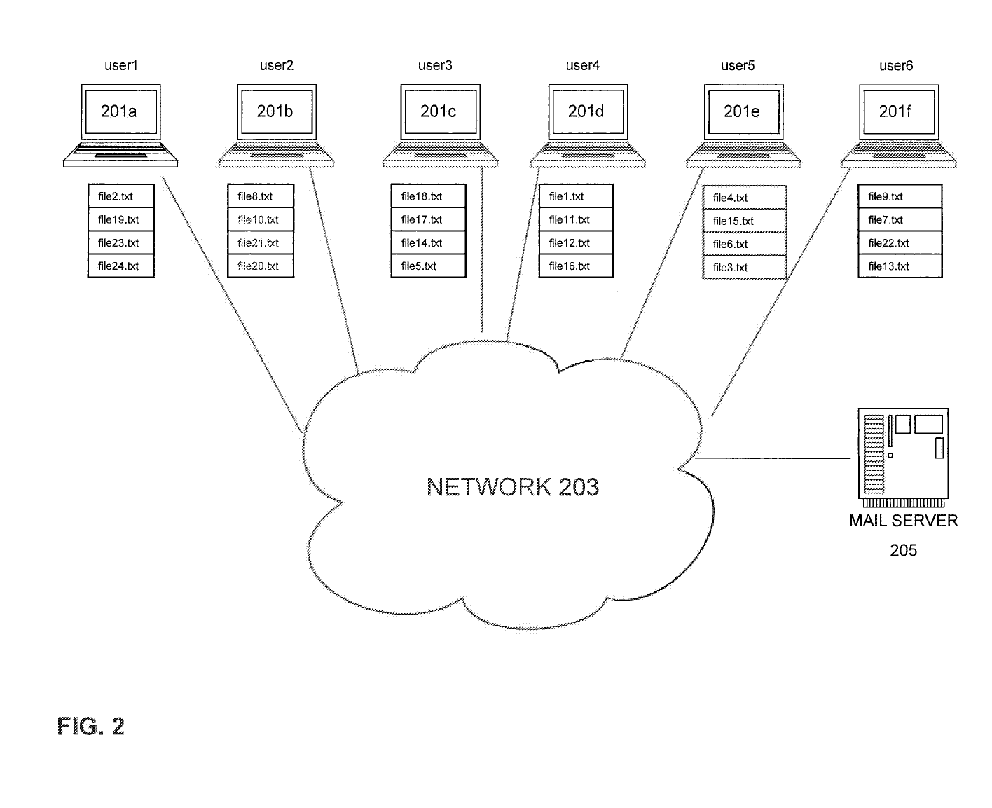

For example, as shown in FIG. 2, user machines 201a through 201f each store four files. Each user machine 201a through 201f may be connected to a network 203, which in turn may connect user machines 201a through 201f to various other machines, such as a mail server 205.

In such a system, the individual user device is a single point of failure. If the device fails for any reason, the data created by the user may be forever inaccessible. For example, if user machine 201a is a portable machine that is lost or destroyed, the files file2.txt, file19.txt, file23.txt and file24.txt may be unrecoverable. This may present legal and other compliance implications, along with an interruption in business.

In the traditional computing environment, conventionally, an electronic discovery vendor hired by a business or law firm tasked to collect and review documents will first create a copy of all data or a subset of data stored on user devices onto a storage device. The vendor may create a complete clone of the user device, or the vendor may extract only particular types of documents. Additionally, the vendor may create a copy of data stored on various servers used by a business, such as a mail server or web server. This process is often labor intensive and time consuming, since the vendor may have to duplicate data stored on many servers, computers, mobile devices, and other electronic communication devices.

In the example of FIG. 2, an electronic discovery vendor may clone or duplicate the storage of user devices 201a through 201f. If user2, for example, creates a new relevant document after the initial collection, the device's storage may have to be re-duplicated to capture the additional document(s). Additionally, if the initial duplication of data focused on electronic mail and text documents, a revised search seeking to include audio data as well may require the vendor or other party to copy data from individual user devices again, this time searching for and copying audio data.

During the collection process, electronic documents such as text files and e-mails may be captured from their native format and converted into image form, such as PDF or TIFF, for future review without a native file viewer. Often, these images are accompanied with the raw text of the native file to be used while searching. One consequence of converting native files into images and raw text is that a relatively small text document may increase in file size once it is converted into an image form. Also, the raw text may lose formatting that may have been present in the original document.

Once the data is copied from user devices, the electronic discovery vendor may load or copy the collected data (images and raw text) into a database for further analysis. Analysis may include filtering out unnecessary documents, marking or tagging particular documents that may be useful, or sending particular documents for further review. Documents are often marked, filtered, or tagged in bulk by way of a query. A vendor may create a query in SQL or other similar database language, and filter or tag a number of documents matching particular criteria.

In a hosted user environment, an individual user device does not store a user's data. Instead, one or more servers store user created data. The advantage of the hosted user environment is that an individual user device failure does not affect the status of any data that user or any other user created.

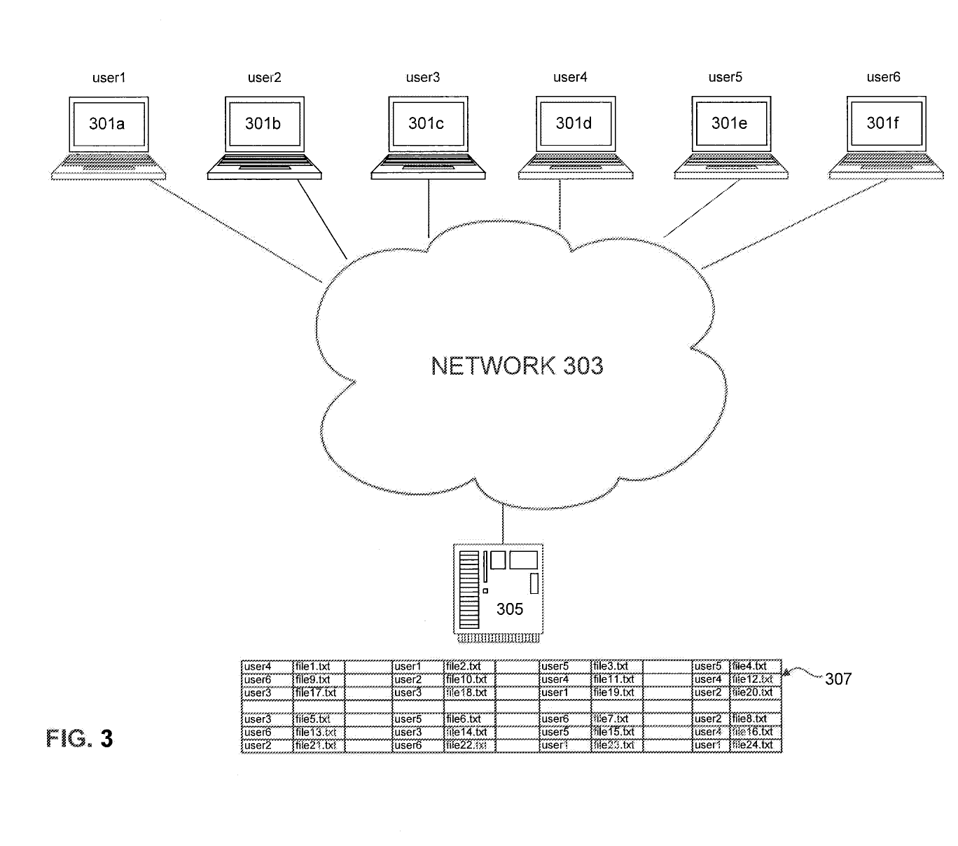

An example of a hosted user environment is shown in FIG. 3. In FIG. 3, user devices 301a-301f are connected to network 303, in a configuration similar to that of FIG. 2. However, in the hosted user environment of FIG. 3, storage server 305 stores file1.txt through file24.txt, and may store an index such as the index 307 that details the owner or creator of each file for access control or other purposes. The index may contain more detail than is shown in FIG. 3. In this way, a failure of an individual user device 301a-301f does not render data inaccessible. Additionally, because the storage server 305 is connected to a network, any device on the network may be able to access the data.

Each of user devices 301a-301f and storage server 305 may be implemented on one or more computing devices. Such a computing device can include, but is not limited to, a personal computer, mobile device such as a mobile telephone, workstation, embedded system, game console, television, or set-top box. Such a computing device may include, but is not limited to, a device having one or more processors and memory for executing and storing instructions. Such a computing device may include software, firmware, hardware, or a combination thereof. Software may include one or more applications and an operating system. Hardware may include, but is not limited to, a processor, memory, graphical user interface display, or a combination thereof. A computing device may include multiple processors or multiple shared or separate memory components. For example, a computing device may include a cluster computing environment or server farm.

Network 303 may be any network or combination of networks that can carry data communication. Such a network 303 may include, but is not limited to, a local area network, medium area network, and/or wide area network such as the Internet. Network 108 can support protocols and technology including, but not limited to, World Wide Web protocols and/or services. Intermediate web servers, gateways, or other servers may be provided between components of the system shown in FIG. 3 depending upon a particular application or environment.

If storage server 305 suffers a performance reduction, user1 through user6 may be affected. Additionally, if storage server 305 fails for any reason, all data may be inaccessible for a period of time. Further, a search of a hosted user environment as in FIG. 3 may take a large amount of time if the amount of data stored on storage server 305 is large. For example, if a given search takes 0.5 seconds per document to execute, a search of 24 documents as in FIG. 3 may take 12 seconds.

Further, electronic discovery in a hosted user environment first involves identifying the server device or server devices used in a company's network. Then, the various storage media of each server, such as hard drives, CD-ROM, tape drives, or other storage media, may need to be duplicated. The users subject to discovery may need to be identified, and their documents and other data extracted. In a large company, a hosted user environment storage device may possess a large number of documents and massive storage devices that would take many hours to duplicate.

Later updating the set of documents encounters similar problems. The storage media of the hosted user environment may need to be re-duplicated, and may take as much time as the initial collection of documents.

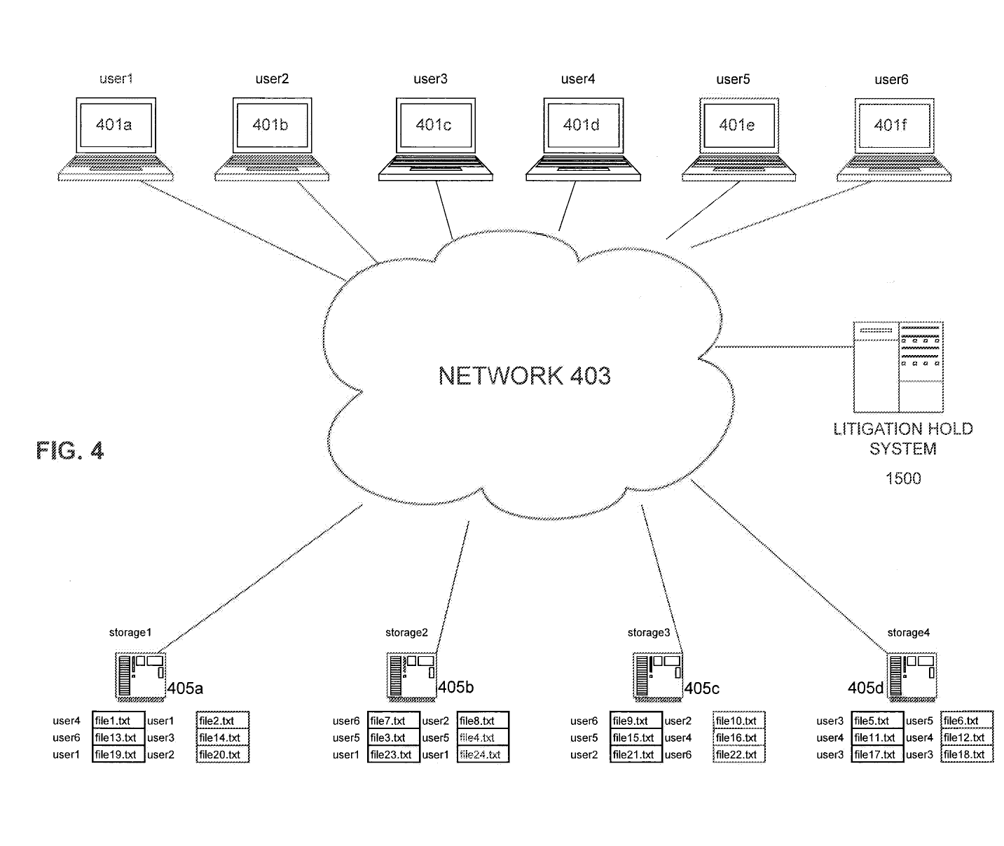

According to an embodiment, an exemplary hosted user environment utilizing a distributed file system is shown in FIG. 4. In FIG. 4, documents are not stored on individual user devices. Instead, documents are spread across a multitude of storage devices 405a-405d. Documents may be distributed equally among the storage devices, as in FIG. 4, or in any other method. Each storage device may have an index of documents stored in it, such as the indices shown in FIG. 4. Each index may contain more data than is shown in FIG. 4. Further, the distributed file system may use a master index to indicate which storage devices 405a-405d hold which files.

Each of user devices 401a-401f and storage servers 405a-405d may be implemented on one or more computing devices. Such a computing device can include, but is not limited to, a personal computer, mobile device such as a mobile telephone, workstation, embedded system, game console, television, or set-top box. Such a computing device may include, but is not limited to, a device having one or more processors and memory for executing and storing instructions. Such a computing device may include software, firmware, hardware, or a combination thereof. Software may include one or more applications and an operating system. Hardware may include, but is not limited to, a processor, memory, graphical user interface display, or a combination thereof. A computing device may include multiple processors or multiple shared or separate memory components. For example, a computing device may include a cluster computing environment or server farm.

Network 403 may be any network or combination of networks that can carry data communication. Such a network 403 may include, but is not limited to, a local area network, medium area network, and/or wide area network such as the Internet. Network 108 can support protocols and technology including, but not limited to, World Wide Web protocols and/or services. Intermediate web servers, gateways, or other servers may be provided between components of the system shown in FIG. 3 depending upon a particular application or environment.

The hosted user environment utilizing a distributed file system shown in FIG. 4 may also include a litigation hold system 1500. Litigation hold system 1500 is further described below in accordance with embodiments described herein.

According to an embodiment, a hosted user environment utilizing a distributed file system such as the one shown in FIG. 4 has a number of advantages over the traditional computing and hosted user environments. For example, a hardware failure in a distributed file system may only affect a small subset of documents. The vast majority of the documents in the environment may still be accessible. Further, search times may be reduced in a distributed file system. In the example above, a given search may take 0.5 seconds per document to execute. In the example of FIG. 4, where each storage device has six documents to search, each storage server may execute the query in 3 seconds. Even including any overhead in retrieving search results from the six servers, the search query execution time is much faster than that of FIG. 3.

Further, a hosted user environment utilizing a distributed file system is scalable. If a company desires more capacity in its hosted user environment, it can add an additional storage device to decrease how many files are stored on an individual device. In terms of the example of FIG. 4, a company could add a fifth storage device, and each storage device may store fewer files.

In a distributed file system, because documents are not stored on individual user devices, electronic discovery tools may need to be adapted to the specific characteristics of the distributed file system. In the hosted user environment of FIG. 3, user documents and data may be stored on one machine that may be duplicated. In a hosted user environment utilizing a distributed file system such as that of FIG. 4, multiple devices may need to be duplicated, and the relevant files must be extracted from each device. As companies grow in size, this solution may become untenable.

Preserving documents in a litigation is of paramount importance. Preventing users from deleting or modifying potentially responsive documents often presents a challenge to corporations and electronic discovery vendors. A consequence of today's reliance on computers in business has led to the majority of discovery in litigation being electronic discovery. This has led to a growth in the need for electronic discovery tools to manage large amounts of data and allow analysis on stored documents. In litigations and administrative proceedings, a court or other body will often compel the production of relevant documents, including electronic documents. In order to review and ultimately produce these documents, law firms and other businesses rely on electronic discovery software packages from various electronic discovery vendors.

In a particular litigation, certain users may be identified as custodians of documents and other data that may be relevant to the matter at hand. When these custodians are identified, their accounts are often placed on “litigation hold.” Litigation hold refers to the process of effectively freezing a user's documents and other data from change, in order to preserve the documents for future use in litigation. For example, in a patent infringement case, an engineer may be placed on litigation hold after his company is sued so that his documents cannot be changed and potential evidence be destroyed.

Imposing this obligation on end-users subject to litigation hold may reduce their productivity. Users placed on litigation hold must be constantly vigilant as to the status of their documents to ensure there are no violations of the litigation hold. Further, in the case of, for example, a temporary employee, the employee may not be aware of the litigation hold or may not know to what extent it should be followed.

This manual approach to imposing a litigation hold presents many risks. Litigations in U.S. courts may take many months or years to ultimately conclude. Thus, a user may need to remember for years that he should not delete or modify any documents of which he has control. In order to ensure that the user is vigilant about keeping his documents, the user may need frequent reminders from attorneys or other compliance personnel. Further, a given user may be subject to more than one litigation hold if his documents may be relevant to more than one litigation. Relying on the end-user to keep track of what documents to keep, and for how long, is ultimately unreliable. Employees also may have collaborated electronically on documents that are not in their possession. A comprehensive litigation hold will seek to keep these documents from further modification as well, but if these documents are not in the employee's possession, this may not be possible.

As more information comes to light and documents are examined in a given litigation, additional employees may be subject to litigation hold. These employees will need to be trained on proper handling of documents during a litigation hold as well.

Companies occasionally contract with outside vendors to help manage litigation holds. Conventionally, these outside vendors will identify users that should be subject to a litigation hold. In order to preserve documents that may be necessary, the vendor may make a copy of a user's computer hard drive and any other storage media used by the user in a traditional computing environment. The vendor may do this for every user subject to litigation hold. In a hosted user environment, the vendor may duplicate the storage server or other centralized storage device.

In order to update the corpus of documents subject to litigation hold, the vendor may need to re-visit the client site and re-clone the hard drive of each user. Additionally, the vendor may identify other users whose data should be cloned to be preserved. The cloning process and updating process may be very time consuming, costly, and require manual intervention.

Searching documents in traditional electronic discovery software packages also may be time consuming. Because most electronic discovery software packages load all documents into a single database, searching performance depends greatly on the specific performance of the device hosting the database. For example, if a particular matter leads to a large amount of documents, executing a search of all documents may take hours or even days.

Tagging, labeling, or other analysis on documents that meet particular criteria also may require a copy of the document, which creates disk space issues.

Electronic documents, along with data comprising the content of the document, usually contain metadata as well. Metadata is generally known as data about data. That is, metadata describes features of the electronic document. For example, metadata for a given document may include the date and time of the document's creation or modification, the author of the document, the names of collaborators of the document, and the size of the document.

Metadata may also include other notes about a document. For example, a user may label a document's metadata with specific text to indicate the document is relevant to a particular subject. Alternatively, a user may label a document's metadata with a notification that it is confidential.

Embodiments of the present invention allow preservation of documents in a hosted user environment to enable electronic discovery. Embodiments described herein may be particularly useful for collecting documents used in electronic discovery software or litigation analysis software. Analysis may include labeling or marking specific documents as relevant, or identifying that the documents pertain to a particular subject.

Embodiments described herein may be used for a distributed collection and searching of relevant documents in a distributed file system. For example, in response to a document request, a user in the legal department may require retrieval of documents relevant to a particular query. The query may run on individual storage devices in a distributed file system to increase performance and reduce execution time.

In a hosted user environment as in the embodiments described herein, when a custodian is placed on litigation hold, a preservation step is triggered to ensure that the custodian's documents are not deleted. These documents may include, for example and without limitation, e-mails in the custodian's account, text documents, spreadsheets, or presentations that the user has created, collaborated on, or is a viewer on.

In an embodiment, documents subject to litigation hold are not collected into a collection set. In a hosted user environment, a query may be performed on individual user accounts to identify documents and data relevant to a litigation. These documents may then be tagged to be placed on litigation hold in their native state, instead of requiring a separate copying operation to take place.

In embodiments, an end user's daily activities are not disturbed in any way by the litigation hold process. In many litigation holds, users are required to actively ensure that they do not delete or modify documents if they are placed on litigation hold. In embodiments described herein, documents are tagged or labeled as being on litigation hold. The tag or label indicating that a document is on litigation hold prevents the document from being deleted or modified in order to comply with the litigation hold. In an embodiment, if a user requests to delete a document, for example, the system will determine that it is on litigation hold and merely remove it from the user's view and preserve it for litigation hold purposes. In an embodiment, if the user requires that the document be modified, a copy of the original document will be made for discovery and preservation purposes, and the user is free to modify the original. On a daily or other basis, a copy of the most recent revision of the document may be created for preservation purposes. Such embodiments remove compliance with the litigation hold from the user's responsibility.

In embodiments, the documents identified as being on litigation hold may also be reviewed by an authorized user, such as a member of a legal department. Queries may be performed on the documents flagged as being on litigation hold, and relevant documents may be identified by a further tag or label. When the time comes for production, only those documents identified as relevant may need to be copied onto separate storage, thereby greatly decreasing the need to copy a large set of data multiple times.

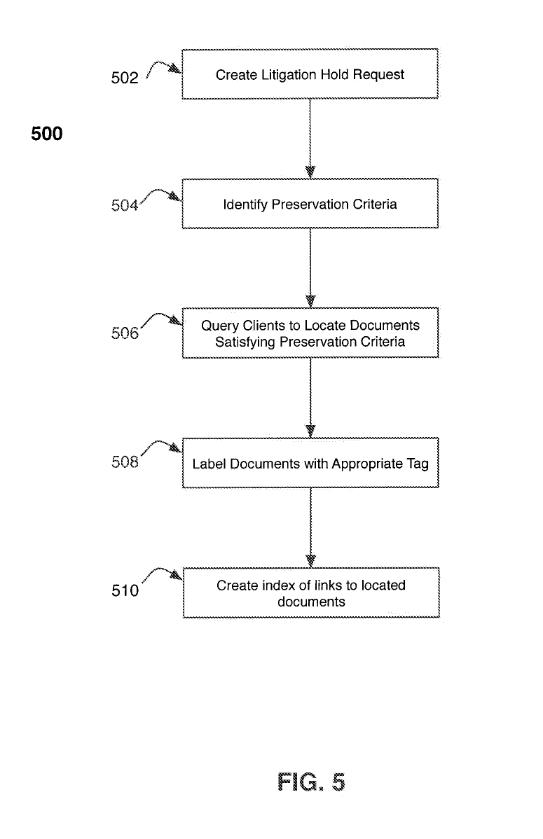

FIG. 5 is an illustration of a method 500 for preserving electronic documents in place for a litigation hold, in accordance with an embodiment. In block 502, a litigation hold request is created. The litigation hold request may identify the litigation and provide a label with which to tag the documents to be placed on litigation hold. The label may include a case name, or other identifying information. In an embodiment, the label may simply be a bit structure to be applied to the electronic documents.

In block 504, preservation criteria of the documents to be placed on litigation hold are identified. Depending on the configuration of the specific systems, criteria may specify a list of user accounts, a document type, documents relating to a particular topic, documents containing particular content, or other criteria. These preservation criteria are used to build a collection query.

At block 506, various client devices, for example, client devices present in a hosted user environment, are queried in accordance with the collection query to locate documents and other data that satisfy the preservation criteria established in accordance with block 504. Client devices may include individual user machines and/or other storage devices, depending on the configuration of the hosted user environment. In the examples described herein, the hosted user environment employs a large number of individual storage systems to store user data and documents, which will be referred to as the client devices. However, the embodiments are not limited in any way to the specific examples described herein.

At block 508, the documents identified in block 506 are labeled with an appropriate label or tag, such as the label or tag specified in block 502, in their native state. For example, a text document may be labeled using word processing software that was used to create the document. Further, a spreadsheet may be labeled using spreadsheet software. A document may also be labeled or tagged by the file system itself. In an embodiment, the tag is a form of metadata stored along with the document. The documents need not be copied to a separate database or storage location. Labeling the documents in their native state, that is, where they exist in their original location in the hosted user environment, eliminates the need for a duplicate copy of relevant data. The label does not modify the underlying document data in any way, preserving the content of the document in accordance with applicable laws and regulations governing litigation holds.

At block 510, an index of links to labeled documents is created so that the documents are accessible by a review tool using the index as a database of documents to be reviewed. The index of links may include other information, such as the time the label was applied, or any other useful information.

An example of an execution of method 500 of FIG. 5, using the various figures and examples explained above, may proceed as follows, in accordance with an embodiment. A company may be subject to a patent litigation infringement for a computer hardware patent. A member of the legal department or another employee thus creates a litigation hold request, and names it Patent-Litigation-1, in accordance with block 502 of FIG. 5.

Additionally, the company's legal department identifies three employees, user1, user3, and user5, that should be subjected to litigation hold in accordance with block 504 of FIG. 5. In accordance with block 504, preservation criteria are established that identify the three users as creating documents that should be placed on litigation hold. An appropriate query is created, in accordance with block 506, to search for the applicable documents.

Using query tools known to those skilled in the art, the query established in accordance with block 506 is executed on storage devices (such as those in FIG. 4) to return the documents created by user1, user3, and user5. Documents identified as belonging to those users are then labeled in their native state, for example, in their metadata, with the tag Patent-Litigation-1 in accordance with block 508 of FIG. 5.

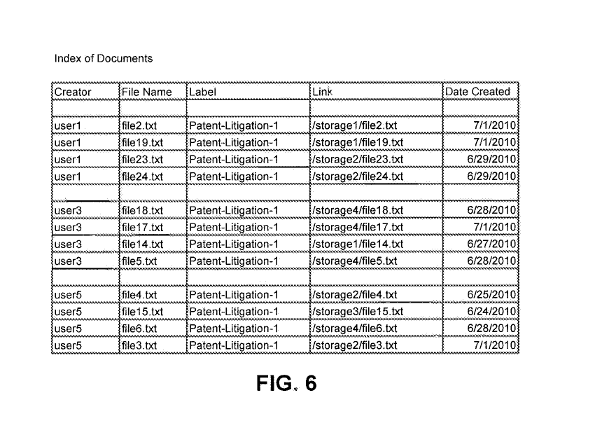

Additionally, an index of documents tagged with the Patent-Litigation-1 label is created to be accessible by a review tool. An example of such an index is shown in FIG. 6. The index may identify, for example and without limitation, the creator of the document, the name of the document, the label applied to each document, the creation date of each document, and/or also may include a link to each document stored across the distributed file system. In this example, the Patent-Litigation-1 label was applied on Jul. 2, 2010.

In an embodiment, a copy of all documents identified at block 506 is maintained. Thus, for example, a copy of documents identified at block 506 may be obtained from client devices and kept in an archive.

In an embodiment, a separate copy of the latest version of all documents in an enterprise is maintained in an archive. As documents are modified, the copy in the archive may be overwritten with the latest copy. In order to preserve documents for a litigation hold, method 500 may be performed on the documents in the enterprise to ensure that the documents subject to litigation hold are not overwritten.

In an embodiment, an authorized user can execute exploratory queries with exploratory criteria on the hosted user environment in order to refine which documents are tagged. For example, a given exploratory query may return a large number of known irrelevant documents. The authorized user then may modify the created query to exclude these known irrelevant documents to streamline the number of documents to be reviewed. Since individual searches take less time, and there is no need to create a separate database of documents, exploratory searching may overall increase performance of a legal review.

The result set of documents located by an exploratory query may be used to generate statistics on the contents of the result set. For example, after formulating an exploratory query and viewing the results of the query, a user may wish to know how many documents in the result set are from a particular custodian, or how many documents in the result set mention a particular word. Thus, analysis may be performed on the results of an exploratory query to return statistics desired by a user.

Analysis performed on an exploratory query result set may allow a user to further refine the eventual preservation criteria to place documents on a litigation hold. For example, as mentioned above, a user may view statistics on how many documents in a particular set mention a desired word. If a large number of documents in the set contain the desired word, the exploratory criteria may be used as preservation criteria in a collection query, as described with respect to block 504 and 506 of method 500. If the documents do not contain the desired word, a user may wish to further refine the exploratory criteria.

Analysis may also reveal other useful statistics to allow a user to refine preservation criteria. For example, if the documents to be searched include e-mail messages, analysis of the result set of the exploratory query may detail the number of e-mail messages sent to a particular recipient, or the number of e-mail messages sent after a particular date. Detailed analysis may use multiple criteria to assist the user in refining preservation criteria. Extending the above examples, analysis may reveal messages sent to a particular recipient after a particular date. Analysis on a result set from an exploratory query may be useful to allocate resources to a particular review of documents subject to litigation hold, or for early case assessment.

In an embodiment, documents are monitored to ensure that the litigation hold is complied with. For example, documents that are labeled may be protected from modification.

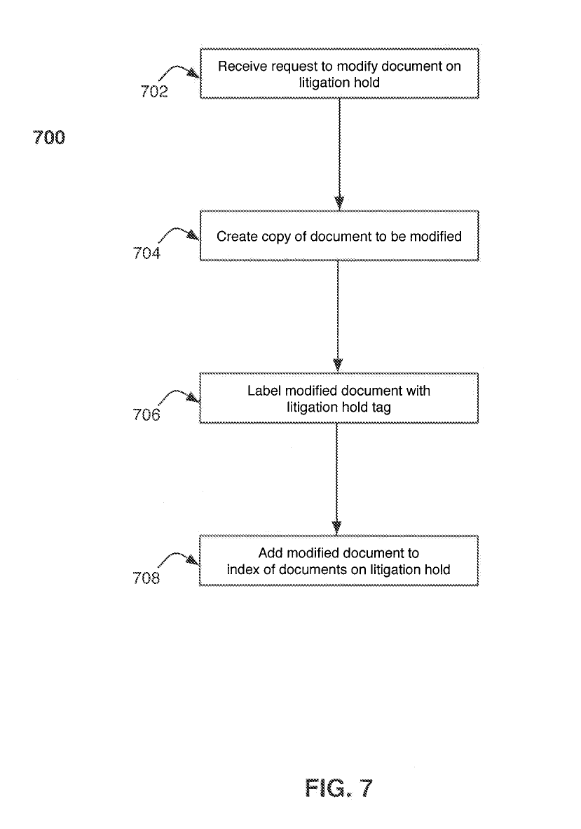

In the ordinary course of business, a user may need to modify a document that he has access to. Compliance with the litigation hold may require that the original document is preserved. A method for ensuring preservation of a document on litigation hold 700 is illustrated in FIG. 7.

In block 702, a request to modify a document on litigation hold is received. For example, a user may need to modify a document before presenting it to other employees.

In block 704, a copy of the document may be created. This is to ensure that the original document is preserved for purposes of the litigation hold. In most litigations, there is a duty of continuing disclosure of relevant documents. That is, after the initial litigation hold, if documents are found that are relevant to the litigation, they must be preserved in the same way as the initial set of documents placed on litigation hold. Therefore, at block 706, the modified document may also be labeled with the litigation hold label. At block 708, an entry may be added to the index of documents subject to litigation hold.

As explained above, a separate copy of the latest version of each document in the enterprise may be maintained in an archive. Thus, in order to ensure preservation of a document on litigation hold, in accordance with method 700, a copy of the document in the archive may be created, and a copy of the modified version may be stored in the archive as well.

In reference to the example above, user3 may need to modify file5.txt on Jul. 3, 2010. Upon modifying the file, because the file is on litigation hold, a copy of the document is created. Because the document remains in its native state while on litigation hold, the software that the user is using to modify the document may perform this operation. For example, if a user is modifying a spreadsheet, the software may recognize the litigation hold label, and be configured to create a copy of the document to preserve the litigation hold. Alternatively, a user's file manager software may recognize the litigation hold label, and also recognize a modification to a document on litigation hold and perform the copying operation. In an embodiment, the user is reminded of the litigation hold via, for example, a pop-up window. Further, a copy of the document may also be created in a separate archive, along with the original version of the document.

Depending on the implementation of this embodiment, the original document may be renamed, so that the user can interact with the modified document without needing to keep track of a new file name. Alternatively, the modified document may be renamed.

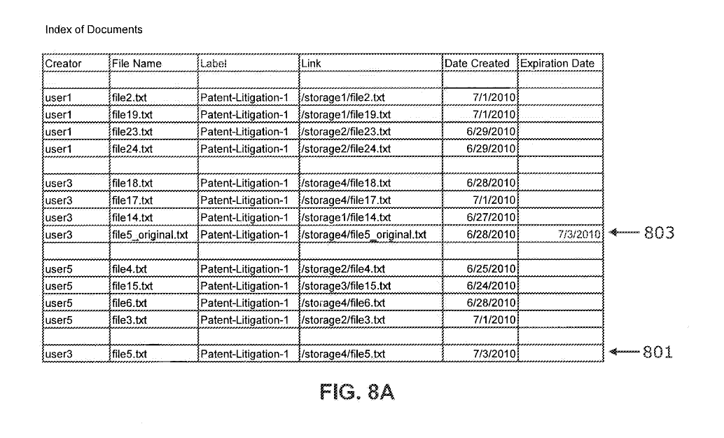

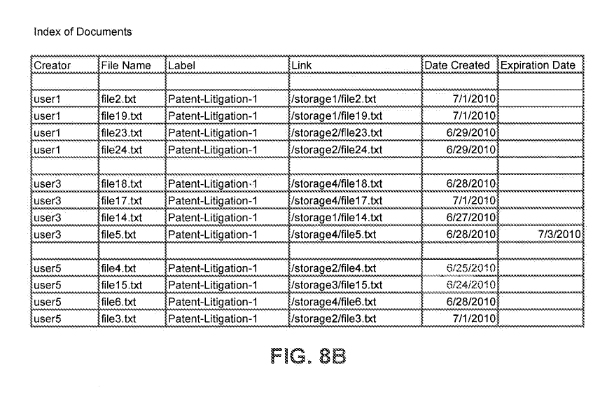

If user3 modifies file5.txt, an entry may be added to the index of documents on litigation hold. An updated index is shown in FIG. 8A. Row 801 is a new entry, which notes that user3 has a document file5.txt that was created on Jul. 3, 2010. Row 803 represents a modification of an existing row, where the file name file5.txt has been changed to file5_original.txt, and the corresponding document link has also been updated.

In an embodiment, an index may be created of documents copied as a result of the litigation hold. In this way, old versions of the document may be purged on termination of the litigation hold in order to save space on the company's network. Alternatively, the index of documents built as a result of the initial litigation hold may identify documents to be deleted at the close of the litigation hold. For example, the index may include an expiration date column, as shown in FIG. 8A. If a document has been modified, the expiration date column may be set to indicate that a new version of the document was created as of the date specified, and the document may be deleted to save system space. In either embodiment, this process takes place with no user intervention. In this way, the user need not be concerned if he is on litigation hold. He can complete his work without being troubled by the intricacies of a litigation hold.

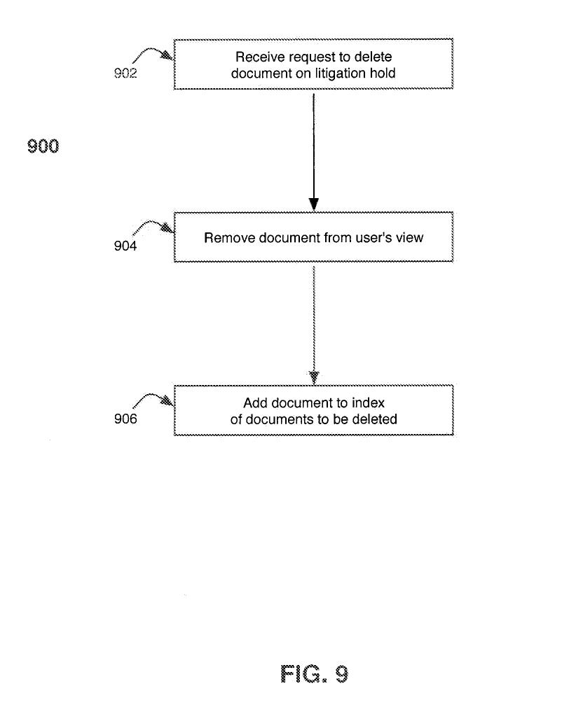

In an embodiment, documents that are labeled are protected from deletion. Compliance with a litigation hold may require that all documents subject to a litigation hold be preserved. A method for preserving deleted documents subject to a litigation hold is illustrated in FIG. 9.

A user subject to litigation hold may wish to delete a document for a number of reasons, such as no longer needing the document. In block 902, a request to delete a document on litigation hold is received. At block 904, in order to lessen user confusion, the document may be removed from a user's view. This may be done, for example, by removing the document from the user's file manager software, or from the software used to create the document. However, the document is maintained in its native state in order to preserve the litigation hold. At block 906, the document is added to an index of documents to be purged at the close of the litigation hold. Alternatively, an additional tag may be associated with the document to denote that the document should be deleted at the close of the litigation hold. The document may be maintained in a separate archive as well.

For example, user3 may wish to delete file5.txt on Jul. 3, 2010. Thus, the document may be removed from user3's view. In addition, the expiration date column may be set to the current date, as shown in FIG. 8B, such that on expiration of the litigation hold, the document is deleted in accordance with the user's request.

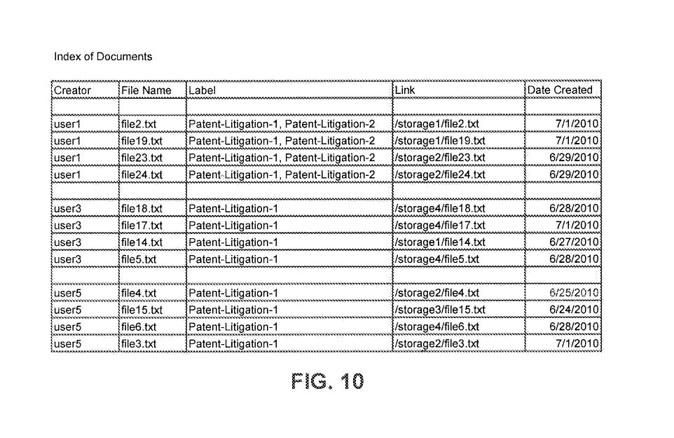

In an embodiment, a particular document may have multiple litigation hold tags attached to it. Extending the above example, if user1 is identified as a custodian in a second patent litigation, documents created by that user may be tagged with the labels Patent-Litigation-1 and Patent-Litigation-2. Such an index is shown in FIG. 10.

If the litigation hold corresponding to Patent-Litigation-1 ends, that label may be removed from the document. If edits to the document occurred between the time the label Patent-Litigation-1 was applied to the document and the label Patent-Litigation-2 was applied to the document, those edits may be merged into the document to save space. In an embodiment, two copies of the document may be created and both labels applied to both copies of the document. When the litigation hold period corresponding to Patent-Litigation-1 is complete, that label may be removed from all revisions of the document. However, the document will remain tagged by Patent-Litigation-2 and protected from deletion or further modification.

In an embodiment, documents to be subject to litigation hold are determined as a result of search queries. For example, in a litigation involving a particular supplier, a company's legal department may seek to place a litigation hold on all documents that mention the supplier. Thus, documents that match the query may be tagged with the name of the supplier.

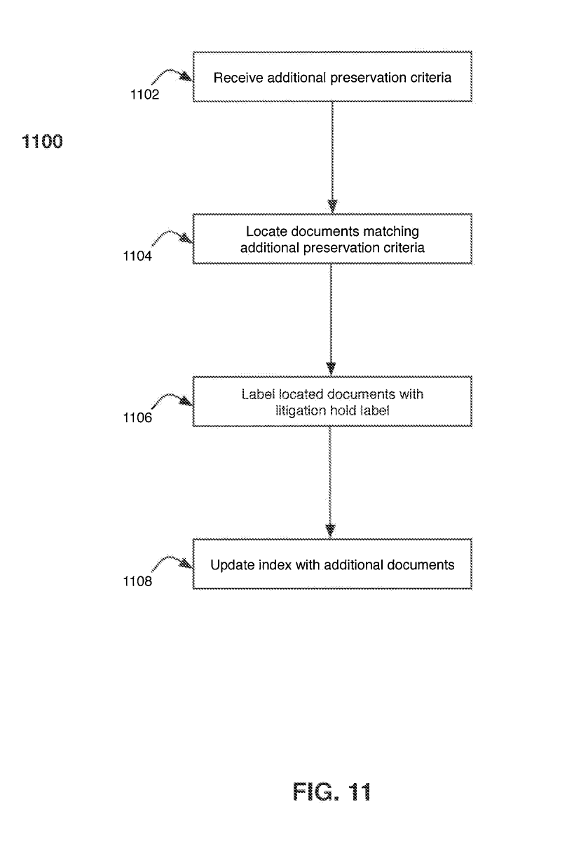

In an embodiment, additional preservation criteria may be received at a later time. For example, a company may identify additional custodians or documents that require preservation. In this embodiment, documents satisfying the additional desired preservation criteria are located across a plurality of client devices, as in the examples described above. An exemplary method in accordance with an embodiment is detailed in FIG. 11.

In block 1102 of FIG. 11, additional preservation criteria are received. Additional preservation criteria may specify another custodian that has been identified as possessing relevant documents. For example, on Jul. 6, 2010, user2 may be identified as a custodian to be placed on litigation hold after the initial litigation hold period commences. At block 1104, documents matching the additional preservation criteria are located across a plurality of client devices. For example, documents may be located across a plurality of storage machines as shown in FIG. 4.

At block 1106, the located documents are labeled with an appropriate label. The label may be specified by the initial preservation criteria established in the first query. For example, user2's documents may be tagged with the Patent-Litigation-1 label. Alternatively, a new label may be established with the updated preservation criteria. The label indicates that the document is on litigation hold and should not be modified or deleted.

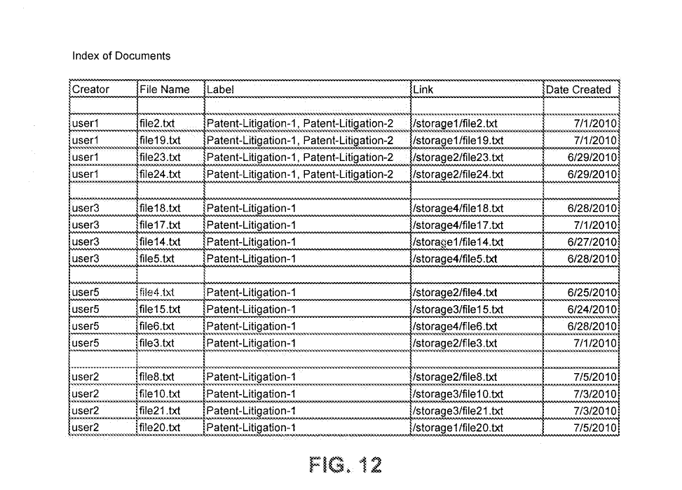

At block 1108, the index of documents and links is updated with the additional documents. An example of an updated index is shown in FIG. 12 with the documents from user2.

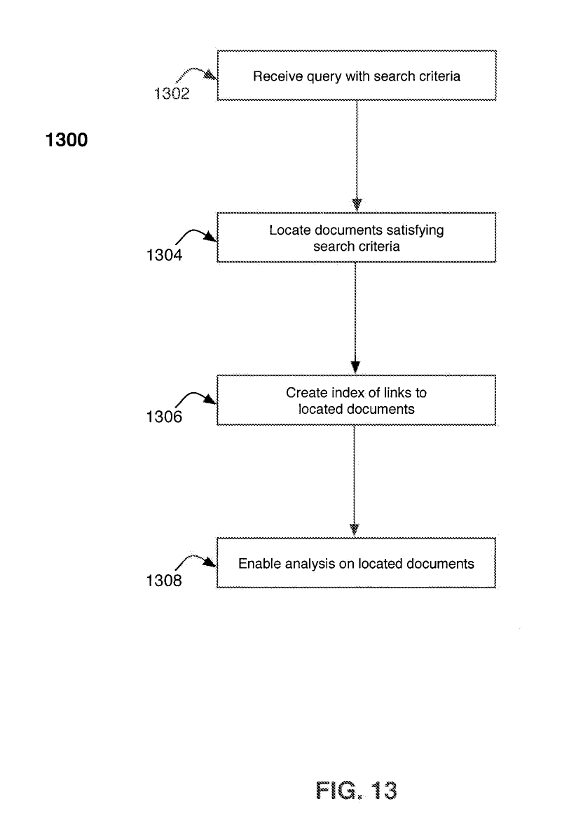

In an embodiment, documents located in a hosted user environment may be reviewed in their native state. FIG. 13 is an illustration of an exemplary method 1300 for enabling review of documents in a hosted user environment according to an embodiment. In a hosted user environment, as detailed above, documents are not stored on individual user's machines. Instead, documents may be accessible over a network, and may be stored on a plurality of storage client devices.

At block 1302, a query with desired search criteria is received. The search criteria may identify various characteristics of documents to be reviewed. For example, a search criteria may identify a group of users whose documents may need review. Alternatively, search criteria may identify characteristics of documents, such as a date of creation, or documents that contain certain text. The search criteria may also include a label to be applied to the documents that are retrieved as a result of the search.

At block 1304, documents satisfying the search criteria are located across a plurality of client devices in a hosted user environment. Client devices may include individual user machines and/or other storage devices, depending on the configuration of the hosted user environment. In the examples described herein, the hosted user environment employs a large number of individual storage systems to store user data and documents, and will be referred to as the client devices. However, the embodiments are not limited in any way to the specific examples described herein. Documents that are found may be labeled, for example, with the label established in block 1302.

At block 1306, an index of links is created. The index links to documents in their native state that satisfy the search criteria. Thus, documents that are found are not copied into a separate database. Rather, in line with the hosted user environment, the documents are located where they are stored in the normal course of business, on whatever client device or storage machine they reside in. Thus, the index of links identifies the name of the document and provides links to view each document in its native state.

At block 1308, analysis is enabled on the documents located in block 1304 by using the index of links created in block 1306. Analysis may be performed in a number of ways. For example, a company may require analysis of how many documents mention a particular phrase. Alternatively, the documents may be reviewed by a member of the legal department as part of a document review process to find relevant documents to be produced in litigation.

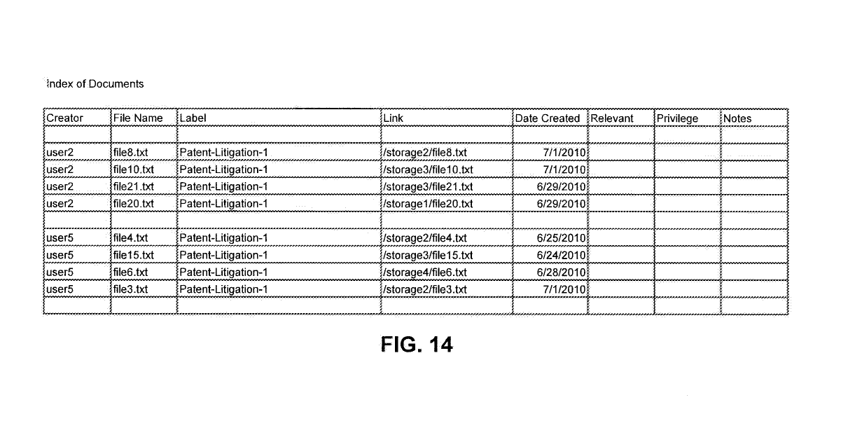

A sample execution of method 1300, according to an embodiment, follows. In this example, search criteria are established to retrieve documents from user2 and user 5. FIG. 14 displays a table of documents and their owners. The various storage machines in a distributed computing environment are queried, and each storage machine may return a list of documents matching the criteria specified in accordance with block 1302 of method 1300.

For example, storage machine storage1 returns a list of one document. Storage machines storage2 and storage3 each return three documents, while storage machine storage4 returns one document as well.

An sample index of links, according to an embodiment, is shown in FIG. 14. The index of links displays the document name, the owner of the document, and a link to the document in its native state.

In an embodiment, the index of links may also include one or more columns to enable analysis of the documents in their native state. For example, the table may allow a reviewer to specify whether the document is relevant, whether it may be subject to attorney-client privilege, or other notes regarding the document.

In an embodiment, the index of links may be used by a document review or electronic discovery tool. The electronic discovery tool may utilize its own analysis criteria while using an index such as that of FIG. 14 to allow users to view the documents to be reviewed.

In an embodiment, the index of links may be divided among one or more reviewers. In this way, if a large set of documents is located, the set may be divided among reviewers to allow users to work in parallel and complete the task in less time than it would one reviewer to do so. Using the above example, one attorney may review user2's documents, while another may review user5's documents, according to an embodiment.

In an embodiment, the index may be divided among reviewers in accordance with desired criteria. For example, depending on the makeup of the reviewers, a particular reviewer may be more suitable to review a particular category of documents. In another example, a certain reviewer may not be permitted to view particular documents. A query may specify criteria to divide the index among reviewers.

Using the above example, user2's documents may be highly technical, while user5's documents may reflect a company's finances. Thus, the reviewer of user2's documents may be an attorney with technical expertise, while the reviewer of user5's documents may have financial knowledge.

In an embodiment, documents placed on litigation hold are converted into an industry standard format upon being placed on litigation hold. For example, text documents may be converted into Portable Document Format (PDF) upon being placed on litigation hold. The conversion process may ensure that documents placed on litigation hold may be reviewed regardless of original file format.

In an embodiment, an eDiscovery or other archive may be utilized to preserve documents on litigation hold. A continuous, synchronous copy of all documents or a particular set of documents distributed across a plurality of client devices in a hosted user environment may be stored in a eDiscovery archive. Documents and other data may be converted into an industry standard format as detailed above. The eDiscovery archive may be implemented in, for example and without limitation, a database.

Upon a preservation request, a label may be placed on the document in the eDiscovery archive. The converted document may then be preserved for litigation hold. On a periodic basis (e.g. hourly or daily), copies of the most recent revisions of documents may be retained, and optionally converted into industry standard format, in order to maintain compliance with a litigation hold.

In an embodiment, if a document is not successfully converted into industry standard format, this failure may be recorded in a log, and the conversion may be attempted again to properly preserve the document.

In many business environments, documents may be shared and edited by multiple users. Users may be subject to litigation hold or not, depending on various criteria. In an embodiment, if a document is shared between more than one user, multiple copies may be retained in the eDiscovery or other archive, in order to comply with the various litigation holds and preservation requirements that may be applicable to the document.

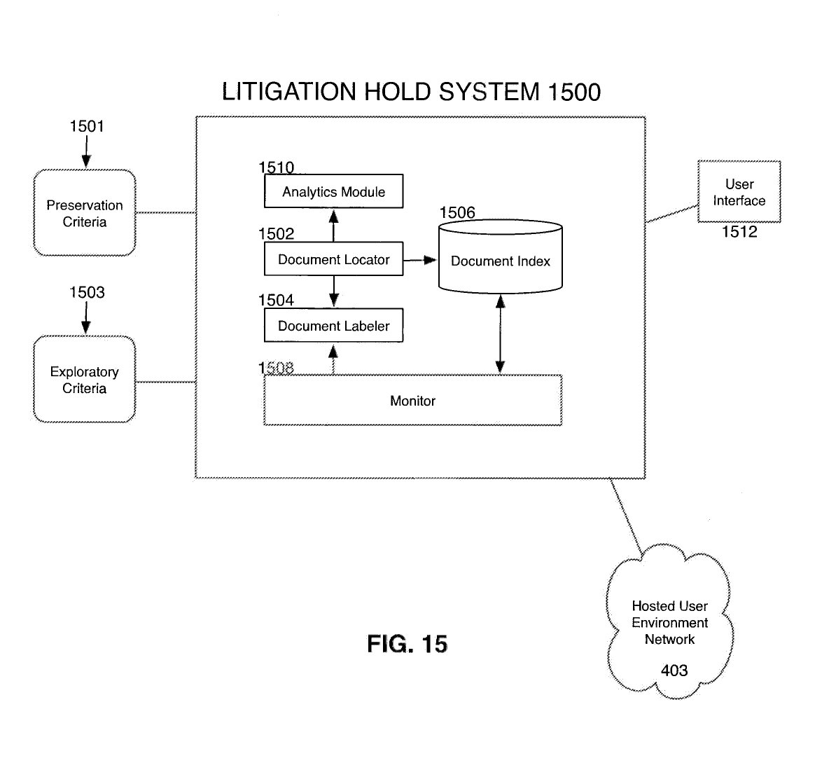

FIG. 15 is an illustration of a litigation hold system 1500 that may be used to implement embodiments described herein. Litigation hold system 1500 includes a document locator 1502, a document labeler 1504, a document index 1506, and monitor 1508.

Litigation hold system 1500 may execute method 500 identified in FIG. 5 and further explained above, but is not limited and may operate in accordance with other embodiments.

In the embodiment shown in FIG. 15, litigation hold system 1500 receives preservation criteria 1501. Litigation hold system 1500 may also receive exploratory criteria 1503.

Preservation criteria and exploratory criteria may include, for example and without limitation, a list of user accounts, a document type, documents relating to a particular topic, documents containing particular content, or other criteria.

Document locator 1502 may query a hosted user environment utilizing a distributed file system to locate documents matching the preservation criteria. In such a hosted user environment, document locator 1502 may query the individual client devices in the hosted user environment to locate documents satisfying the preservation criteria.

Document labeler 1504 may tag or label documents returned from document locator 1502 with a label, such as the label or tag established with respect to block 502 of method 500.

Litigation hold system 1500 also may maintain a document index 1506 created to keep an index of links to documents on litigation hold. Such an index may be similar to the index of FIG. 6. In an embodiment, document index 1506 allows for further analysis of the documents on litigation hold, similar to the index shown in FIG. 14.

Litigation hold system 1500 may also include a monitor 1508. Utilizing document index 1506, monitor 1508 may keep track of documents in the hosted user environment to ensure compliance with a litigation hold, in accordance with an embodiment. Monitor 1508 may also periodically query the hosted user environment for newly created documents satisfying the preservation criteria, in accordance with an embodiment.

Litigation hold system 1500 may also include an analytics module 1510. Analytics module 1510 may calculate statistics on documents returned from document locator 1502 as a result of preservation or exploratory criteria.

Litigation hold system 1500 described herein can be implemented in software, firmware, hardware, or any combination thereof. The litigation hold system can be implemented to run on any type of processing device including, but not limited to, a computer, workstation, distributed computing system, embedded system, stand-alone electronic device, networked device, mobile device, set-top box, television, or other type of processor or computer system.

Litigation hold system 1500 may be connected to a network in a hosted user environment utilizing a distributed file system, such as network 403 described with respect to FIG. 4. In this way, litigation hold system 1500 may access the data stored on storage 405a-405d to implement embodiments described herein. Additionally, a user interface 1512 may be provided to litigation hold system 1500. Alternatively, instructions implementing litigation hold system 1500 may be provided to each storage device in the hosted user environment.

Embodiments may be implemented in hardware, software, firmware, or a combination thereof. Embodiments may be implemented via a set of programs running in parallel on multiple machines. In an embodiment, different stages of the described methods may be partitioned according to, for example, the number of documents on each storage machine, and distributed on the set of available machines.

The summary and abstract sections may set forth one or more but not all exemplary embodiments of the present invention as contemplated by the inventor(s), and thus, are not intended to limit the present invention and the appended claims in any way.

Embodiments of the present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A computer-implemented method of preserving documents for a litigation hold, comprising:
receiving one or more preservation criteria for a litigation hold;
locating, by a processor, documents satisfying the preservation criteria across a plurality of client devices;
labeling the located documents by the processor, wherein the label is an indication that the document is on the litigation hold and should not be modified or deleted; and
maintaining an index of links to the labeled documents, such that the documents are maintained in their respective client devices while accessible by a review tool.

2. The method of claim 1, further comprising the step of creating an exploratory query to test preservation criteria before labeling documents.

3. The method of claim 1, further comprising:
monitoring documents subject to the litigation hold;
receiving a request to modify a document subject to the litigation hold; and
creating a copy of the document requested to be modified in order to preserve the original for litigation hold purposes.

4. The method of claim 1, further comprising:
monitoring documents subject to litigation hold;
receiving a request to delete a document subject to litigation hold;
removing the document requested for deletion from a user's view; and
maintaining the document in its respective client device for litigation hold purposes.

5. The method of claim 1, wherein a document may have one or more labels.

6. The method of claim 1, further comprising:
receiving additional desired preservation criteria;
locating, documents satisfying the additional desired preservation criteria across a plurality of client devices;
labeling the located documents; wherein the label is an indication that the document is on litigation hold and should not be modified or deleted; and
updating the index of links to include links to the labeled documents.

7. The method of claim 1, further comprising:
removing a label from a document upon termination of the litigation hold.

8. A method of enabling review of documents in a hosted user environment, comprising:
receiving, by a processor, a query to return documents in accordance with desired search criteria;
locating, by the processor, documents satisfying the search criteria across a plurality of client devices;
creating, by the processor, an index of links to documents in their native state that satisfy the search criteria; and
providing access to the index of links to documents, while maintaining the documents in their native state to enable analysis on documents satisfying the search criteria.

9. The method of claim 8, further comprising:
dividing the index of links to documents satisfying the search criteria among one or more reviewers.

10. The method of claim 9, wherein the index is divided among reviewers in accordance with desired criteria.

11. A litigation hold system for preserving documents under a litigation hold in a hosted user environment, comprising:
a preservation criteria receiver that receives criteria of documents to be placed on litigation hold;
a document locator that queries client devices in a hosted user environment and locates documents corresponding to received preservation criteria;
a document labeler that labels the located documents with an indication that the document is on litigation hold and should not be modified or deleted; and
a document index that maintains an index of links to the labeled documents, such that the documents are maintained in their respective client devices while accessible by a review tool.

12. The litigation hold system of claim 11, further comprising a monitor that ensures compliance with the litigation hold by monitoring modifications and deletions of documents in the hosted user environment.

13. The litigation hold system of claim 12, wherein the monitor periodically queries the hosted user environment for newly created documents satisfying received preservation criteria.

14. The litigation hold system of claim 12, wherein the monitor is further configured to:
receive a request to modify a document on litigation hold;
create a copy of the original document to be modified to ensure compliance with the litigation hold; and
maintain a copy of the modified document to ensure compliance with the litigation hold.

15. The litigation hold system of claim 12, wherein the monitor is further configured to:
receive a request to delete a document on litigation hold; and
maintain the document in its native client device while removing the document from a user's view.

16. The litigation hold system of claim 11, further comprising an analytics module that calculates statistics on documents located by the document locator.

17. The litigation hold system of claim 11, further comprising:
an exploratory preservation criteria receiver that receives exploratory preservation criteria; and
a preservation criteria finalizer that creates preservation criteria of documents to be placed on litigation hold.

18. A computer readable storage medium having a plurality of instructions stored thereon that, when executed by one or more processors, cause the one or more processors to execute a method of preserving documents under a litigation hold, the method comprising:
receiving one or more preservation criteria for a litigation hold;
locating documents satisfying the preservation criteria across a plurality of client devices;
labeling the located documents, wherein the label is an indication that the document is on the litigation hold and should not be modified or deleted; and
maintaining an index of links to the labeled documents, such that the documents are maintained in their respective client devices while accessible by a review tool.
